(19) United States
(12) Patent Application Publication
(10) Pub. No.: US 2024/0111529 A1
(43) Pub. Date: Apr. 4, 2024

(54) VECTOR PROCESSING UNIT WITH PROGRAMMABLE MULTICYCLE SHUFFLE UNIT

(71) Applicant: ADVANCED MICRO DEVICES, INC., SANTA CLARA, CA (US)

(72) Inventors: ERIC DIXON, FORT COLLINS, CO (US); MICHAEL ESTLICK, FORT COLLINS, CO (US); ERIK D. SWANSON, FORT COLLINS, CO (US)

(21) Appl. No.: 17/957,672

(22) Filed: Sep. 30, 2022

(51) Int. Cl. G06F 9/30; G06F 9/345

(52) U.S. Cl. CPC G06F 9/30036; G06F 9/3012; G06F 9/345

(57) ABSTRACT

An integrated circuit includes a vector data processing unit that employs a cross-lane shuffle unit including multiplexing logic that programmably shuffles packed source lane values, each corresponding to one of a plurality of vector lanes, to different output vector result lane positions over multiple cycles. In certain implementations, in a first cycle, control logic in the cross-shuffle unit controls the multiplexing logic to select source lane values to be placed in a first group of output vector result lane positions for a vector result register; and in at least a second cycle, the same multiplexing logic is reused to select source lane values to be placed in a second group of output vector result lane positions for the vector result register wherein at least one of the selected source lane values is moved to a different result lane position. Associated methods are also presented.

### BACKGROUND OF THE DISCLOSURE

Integrated circuits and system on chips (SoC's) employ multiple processing cores such as central processing unit (CPU) cores, graphic processing units (GPU) cores, vector processing units (VPUs), such as floating point units (FPUs) and other processing units that execute instructions. In some implementations, CPU or GPU cores dispatch instructions to one or more vector processing units to carry out vector processing operations on data. Vector processing units, as known in the art may employ datapaths that employ single instruction multiple data units (SIMD) or other structures, configured in vector lanes, to process vector data. Such operations are increasingly useful for cloud based machine learning operations, artificial intelligence operations, for gaming applications and for other applications.

Vector processing units, are known to use shuffle units that move (shuffle) lane values among FPU vector lanes for certain instructions to different output vector lane positions. For example, FPUs employ shuffle units that can move certain packed floating point values from a 256 FP input vector in chunks of 64 bits to different 4 possible positions (4 lanes) in a 256 bit FP output vector result (or 64 bit values to different 8 positions corresponding to 8 lanes for a 512 bit output vector result). However, for the 256 bit FP input vector, this structure can only move 4 lanes of input values to 4 output lanes. There is a full multiplexer per lane of vector width. Also, for a 512 bit instruction this arrangement would require a full multiplexer per lane of vector width which requires a dedicated per output vector lane multiplexer and flop hardware (storage element) for the full width of the output vector. Such structures can be costly in terms increasing die size of the integrated circuit that employs the VPUs, and/or adding power consumption, and/or adding design complexity to vector operation circuits. Additionally, this may result in slower execution speed of the system employing such a structure. Systems employing such structures such as, for example, computer servers providing cloud based machine learning operations and/or artificial intelligence operations, are particularly sensitive to costs, power consumption and speed of execution.

### BRIEF DESCRIPTION OF THE DRAWINGS

The implementations will be more readily understood in view of the following description when accompanied by the below figures, wherein like reference numerals represent like elements, and wherein:

FIG. 1 illustrates a block diagram of an apparatus that employs a vector processing unit with a multicycle lane cross-shuffle unit in accordance with one example set forth in the disclosure;

FIG. 2 illustrates a block diagram of an integrated circuit that employs a vector processing unit with a multicycle lane cross-shuffle unit in accordance with one example set forth in the disclosure;

FIG. 3 is a flowchart illustrating a method for shuffling vector data to different lanes in accordance with one example set forth in the disclosure;

FIG. 4 is a block diagram illustrating multicycle lane cross shuffling unit control logic in accordance with one example set forth in the disclosure;

FIG. 5 is a flowchart illustrating a method for shuffling vector data s in accordance with one example set forth in the disclosure; and

FIG. 6 is a diagram illustrating a multicycle vector lane shuffling operation in accordance with one example set forth in the disclosure.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF IMPLEMENTATIONS

In some implementations, a VPU includes a shuffle unit that programmably selects lane level control multiplexers over multiple operating cycles and reuses the same multiplexers that allow any input source value from any input vector lane position to be placed in any output result vector lane position. The VPU shuffle unit is programmable using specific operation codes and, in some implementations, operates using multiple source operands to use data from multiple source registers that include packed source lane vector values.

In some implementations, an integrated circuit incudes a vector data processing unit that employs a cross-lane shuffle unit including multiplexing logic that programmably shuffles packed source lane values, each corresponding to one of a plurality of vector lanes, to different output vector result lane positions over multiple cycles. In certain implementations, in a first cycle, control logic in the cross-shuffle unit controls the multiplexing logic to select source lane values to be placed in a first group of output vector result lane positions for a vector result register; and in at least a second cycle, the same multiplexing logic is reused to select source lane values to be placed in a second group of output vector result lane positions for the vector result register wherein at least one of the selected source lane values is moved to a different result lane position. In certain implementations the vector result register is populated with the shuffled lane result values and used a as source register with another vector processing instruction, stored to memory or further processed as desired.

In some implementations, the multiplexing logic includes a multiplexer per result lane wherein each multiplexer includes an input coupled to receive all of the source lane values, and an output that provides a result lane value per result lane position. In some implementations, the multiplexing logic includes a fewer number of result lanes than a number of the plurality of vector lanes and the vector processing unit stores the result lane values from both the first and second cycles in the vector result register as packed vector lane values. The vector result register is stored as part of a register file for the VPU.

In certain implementations, each multiplexer output is coupled to a respective result lane storage element that stores the selected source values output from each multiplexer during each of the first and at least second cycle. In some implementations, the control logic controls the respective result storage elements to store result lane values based on which cycle is being processed, such as indicated by a cycle identifier. In some implementations the result lane storage element for each result lane includes a set of flip flops that are reused on each cycle to store source lane values that are selected in each cycle. In other implementations, the result lane storage element for each result lane includes a set of flip flops dedicated for each cycle used. For example, each respective result lane storage element includes a first set of latches corresponding to the first cycle and at least a second set of latches corresponding to the second cycle.

In certain implementations, control logic programmably controls the multiplexing logic to provide multicycle lane shuffling in response to an instruction. In some implementations the instructions uses a plurality of source operands to employ a plurality of source lane registers that include source lane values.

In certain implementations, when there are sets of dedicated storage elements for each result lane, the cross-lane shuffle unit places the selected source lane values from the first cycle into a first set of vector result lane storage elements; place the selected source lane values from the second cycle into a second set of vector result lane storage elements; and store contents of the two sets of storage elements into a vector result lane register having a same number of positions as the plurality of vector lanes.

In some implementations, when there is only one set of storage elements for each result lane, the cross-lane shuffle unit places the selected source lane values from the first cycle into a first set of vector result lane storage elements as first vector result lane values; move the first vector result lane values to a vector result lane register; place the selected source lane values from the second cycle into the first set of vector result lane storage elements as second vector result lane values; and move the second vector result lane values to the same vector result lane register to concatenate the first and second vector lane values into the vector result lane register.

In certain implementations, the vector processing unit includes the plurality of vector lanes each operative to perform an operation on input vector data, such as from a source register or raw vector data, and produce respective source lane values for each lane. The vector processing unit packs the source lane values in a source register.

In certain implementations, an apparatus includes a multicore processor, such as a multicore CPU, GPU, APU or other processor that employs floating point units and includes a plurality of processing cores, a plurality of floating point processing units (FPUs) wherein each of the FPUs is in operative communication with at least one of the plurality of processing cores, and wherein each of the plurality of (FPUs) comprises: a plurality of FPU lanes each operative to perform a floating point operation on input vector data and produce respective source lane values for each lane and store the source lane values a lane storage element such as a register file; and a cross-lane shuffle unit that programmably shuffles the respective source lane values from the plurality of FPU lanes to different output vector result lane positions.

The cross-shuffle lane unit includes multiplexing logic having an output result lane configuration of fewer result lanes than a number of FPU lanes and control logic that provides multicycle lane shuffling by: in a first cycle, controlling the multiplexing logic to select source lane values to be placed in a first group of output vector result lane positions for a vector result register; and in at least a second cycle, reusing the multiplexing logic to select source lane values to be placed in a second group of output vector result lane positions for the vector result register wherein at least one of the selected source lane values is moved to a different result lane position.

In some implementations, the multiplexing logic includes a multiplexer per result lane wherein each multiplexer includes an input coupled to receive all of the source lane values, and an output that provides a result lane value per result lane position.

In certain implementations, each multiplexer output is coupled to a respective result lane storage element that stores the selected source values output from each multiplexer during each of the first and at least second cycle and the control logic controls the respective result storage elements to store lane values based on which cycle is being processed.

In certain implementations, control logic programmably controls the multiplexing logic to provide multicycle lane shuffling in response to an instruction. In some implementations, each respective result lane storage element includes a first set of latches corresponding to the first cycle and at least a second set of latches corresponding to the second cycle.

In certain implementations, the cross-lane shuffle unit of the apparatus places the selected source lane values from the first cycle into a first set of vector result lane storage elements; places the selected source lane values from the second cycle into a second set of vector result lane storage elements; and stores contents of the two sets of storage elements into a vector result lane register having a same number of positions as the plurality of vector lanes.

In some implementations, the cross-lane shuffle unit of the apparatus places the selected source lane values from the first cycle into a first set of vector result lane storage elements as first vector result lane values; moves the first vector result lane values to a vector result lane register; places the selected source lane values from the second cycle into the first set of vector result lane storage elements as second vector result lane values; and moves the second vector result lane values to the same vector result lane register to concatenate the first and second vector lane values into the vector result lane register.

In certain implementations, a method carried out by a vector data processing unit, includes shuffling packed source lane values, each corresponding to one of a plurality of vector lanes, to different output vector result lane positions by: in a first cycle, controlling multiplexing logic to select source lane values to be placed in a first group of output vector result lane positions for a vector result register; in at least a second cycle, reusing the multiplexing logic to select source lane values to be placed in a second group of output vector result lane positions for the vector result register wherein at least one of the selected source lane values is moved to a different result lane position; and storing the shuffled vector lane data from both the first and second cycles as packed lane values in the vector result register.

In certain implementations, the method includes controlling an output result lane storage element for each vector result lane position to store selected source lane values based on which cycle is being processed.

In certain implementations, the method includes controlling each respective result storage element such that a first set of storage elements stores result data from the multiplexing logic during the first cycle and at least a second set of storage elements stores result data from the multiplexing logic during the second cycle.

In some examples, the method includes placing the selected source lane values from the first cycle into a first set of vector result lane storage elements as first vector result lane values; moving the first vector result lane values to a vector result lane register; placing the selected source lane values from the second cycle into the first set of vector result lane storage elements as second vector result lane values; and moving the second vector result lane values to the same vector result lane register to concatenate the first and second vector lane values into the vector result lane register.

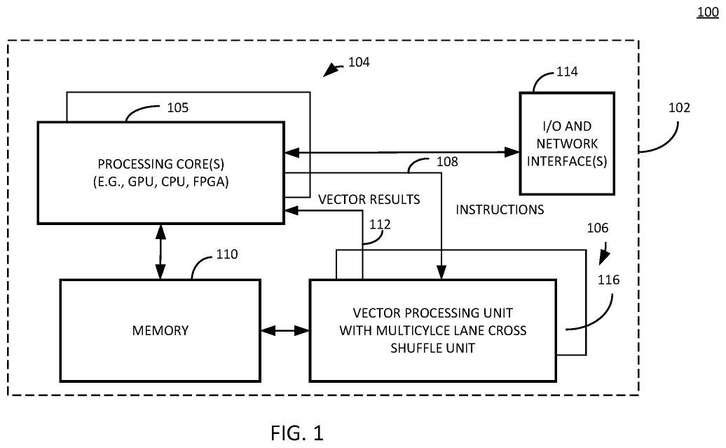

FIG. 1 is a block diagram illustrating one embodiment of an computer processing system 100, such as a system on chip, data center server, laptop, mobile phone, internet appliance, or other suitable device that employs an integrated circuit 102 that in some implementations employs one or more processing units 104. The one or more processing units 104 are configured to execute instructions stored in system memory 110 and in some examples, include a plurality of processing cores 105 such as CPU cores, GPU cores or other processing device that utilizes one or more vector processing units 106 such as floating point units (FPUs), or other suitable vector processing units that execute instructions and use register files. In this example, a plurality of VPUs 106, such as floating point processing units (FPUs) that employ single instruction multiple data (SIMD) units in vector lanes, are in operative communication with at least one of the plurality of processing cores. In this example, the vector processing units 106 employ a multicycle lane cross shuffling unit as further described below that programmably shuffles source lane values from source vector lane positions to different result lane positions as desired. In some implementations, the multicycle lane cross-shuffle unit selects lane level control multiplexers over multiple operating cycles and reuses the same multiplexers allowing any input source value from any input vector lane position to be placed in any output result vector lane position. Vector results 112 are provided if desired, to a requesting processing core, and/or are stored in memory 110 which, in this example, represents multiple types of memory including register files used by the VPU, and/or the vector results are used by the VPU in further processing operations. An I/O and network interface 114, if desired, allows the processing cores to communicate through a data fabric or other interfaces to memory complexes, processor complexes or other devices as known in the art.

In some implementations, a processing unit 104 includes a prefetch unit coupled to an instruction cache. A dispatch unit in some implementations is configured to receive instructions from the instruction cache and to dispatch operations 108 to the VPU 106. One or more schedulers are coupled to receive dispatched operations from the dispatch unit and to issue operations to the one or more processing units (e.g., FPU's) in the VPU. The processing units include execution cores that may include, for example, one or more floating point units that employ vector lanes.

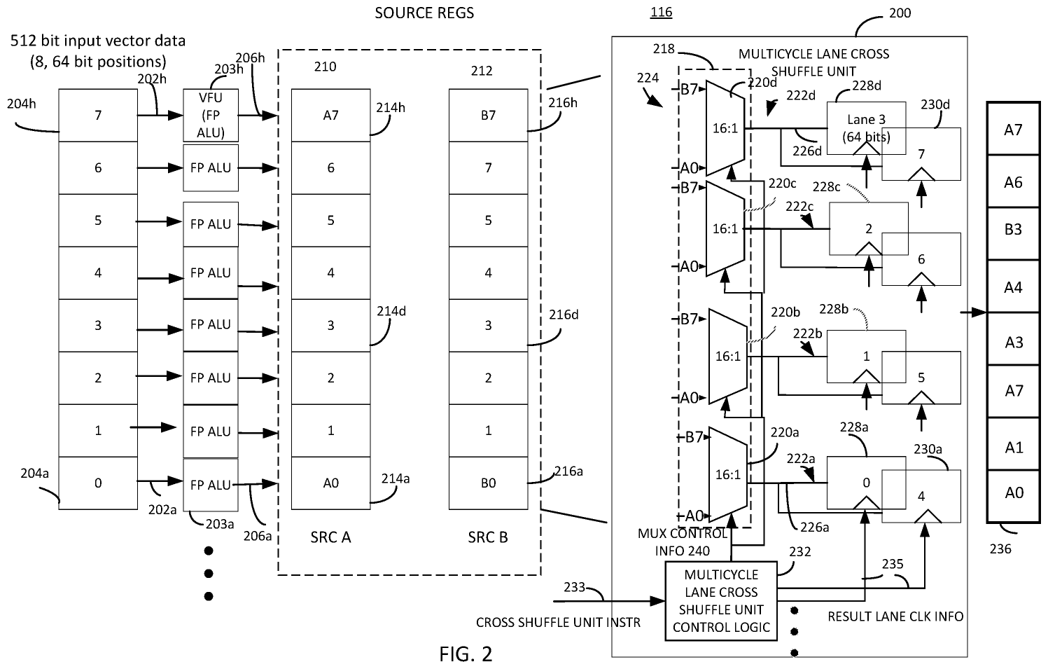

FIG. 2 is a block diagram of integrated circuit 102 that employs a vector processing unit 116 with a multicycle cross-lane shuffle unit 200. In this example, the VPU 116 includes a plurality of vector lanes 202a-202h, shown as a plurality of FPU vector lanes. Each vector lane includes a vector functional unit (VFU) 203a-203h, that performs a floating point operation on input vector data 204a-204h (elements 204b-204g, not illustrated for ease of understanding) and produces respective source lane values 206a-206h (elements 206b-206g not illustrated for ease of understanding) for each lane as known in the art. The input vector data is stored in a memory such as a register file as a vector register that includes packed vector lane values 204a-204h for all eight lanes (0-7) in this example. In this example the input vector data is 512 bits with each input vector lane value being 64 bits. The eight lanes represent one execution pipe of the VPU. The circuitry is duplicated for other execution pipes.

In this example, where V=Vector length; L=number of vector lanes; Z=V/L=lane value size; and N=number of sources, V=512 [511:0]; L=8 [7:0] and Z=64 bits [63:0]. As such, the input vector data is 512 bits; there are 8 lanes per execution pipe where each lane outputs a vector value of 64 bits, and there are two sources (source A and source B illustrated as “SRC A” and “SRC B”, respectively) wherein each source includes eight packed source vector values so that a total of 16 sources are fed to the multiplexers and any vector value from any source lane position can be output on any of the result lane positions.

The source lane values 206a-206h are stored in a register in a source register file as packed source lane values so that the lanes values for all eight lanes are packed into the same register corresponding to lane positions as known in the art. In this example, a shuffle instruction has been issued that employs two operands each identifying source registers 210 and 212 in a register file. The two retrieved source registers are shown as source register A 210 (SRC A) with packed source lane values 214a-214h in lane positions A0-A7 and source register B 212 (SRC B) with packed lane source values 216a-216h in lane positions B0-B7 for a total of 16 source vector values (8 lanes and two sources). It will be recognized that the source register vector values can be raw vector data, or results from prior shuffles, or prior results from the vector lanes. It will also be recognized that the source registers can be of any suitable size. In this example they each store 8 lanes of 64 bit lane values for 2 sets of 512 bit vector data.

The cross-lane shuffle unit 200 includes multiplexing logic 218 that includes a multiplexer 220a-220d per result lane 222a-222d wherein each multiplexer 220a-220d includes an input 224 coupled to receive each of the source lane values 214a-214h and 216a-216h from both source registers 210 and 212. In this example there are 16 source lane values to select from such that each multiplexer 220a-220b receives all 16 source lane values so that any of the source lane values can be selected to move to the result lane position(s) associated with a given multiplexer. Each multiplexer has an output 226a-226d that provides a result lane value per result lane position. In this example, the multiplexing logic 218 includes a fewer number of result lanes than a number of the plurality of vector lanes. For example, there are 8 vector lanes and only 4 result lane outputs from the multiplexing logic 218. In some examples, each multiplexer output 226a-226d is coupled to one or more respective result lane storage elements 228a-228d and 230a-230d that stores the selected source lane values output from each multiplexer during each of at least a first and at least a second cycle. In some implementations, each respective vector result lane storage element stores a selected source lane 64-bit value. In certain implementations, each respective vector result lane storage element 228a-230d includes a first set of latches corresponding to the first cycle and at least a second set of latches corresponding to the second cycle. In this example, each set of latches stores a selected source lane 64-bit value.

In this example there are two result lane storage elements coupled to each multiplexer output so that four multiplexers are controlled to shuffle any of 16 source lane values to any of 8 result lane positions but this is done in two operational cycles (also referred to as two pumps). As shown, multiplexer 220a provides lane values for result lane positions 0 and 4 via lane storage elements 228a and 230a over multiple cycles (two in this example). Similarly, multiplexer 220b provides lane values for result lane positions 1 and 5 via lane storage elements 228b and 230b; multiplexer 220c provides lane values for result lane positions 2 and 6 via lane storage elements 228c and 230c and multiplexer 220d provides lane values for result lane positions 3 and 7 via lane storage elements 228d and 230d. The lane values that are latched from the multiplexers 220a-220d via lane clock information 235 are stored in the vector result register 236.

The multicycle lane cross-shuffle unit includes control logic 232 (shown as a multicycle lane cross-shuffle unit controller and referenced as “control logic 232”) that programmably controls the multiplexing logic 218 to provide multicycle lane shuffling in response to an instruction. In some implementations a cross-shuffle unit instruction 233 uses one or more op codes and a plurality of source operands to employ a plurality of source lane registers. The control logic 232 in one example is a programmable controller that executes micro opcodes but may be any suitable structure configured to carry out the operations as described herein including one or more state machines, field programmable arrays or other logic.

In this example, an opcode and two source operands are used for the shuffle instruction, however any suitable number of opcodes and operands can be used. The control logic 232 receives a cross-shuffle unit instruction 233 and, based on the instruction, issues multiplexer control information 240 to select the appropriate multiplexers to select the appropriate source lane values to output as the lane values for the vector result register 236. The control information 240 in some examples include control bits to select one or more multiplexers and to select a corresponding input source lane value for the multiplexer. In some implementations a mux identifier and input select identifier for each mux is determined from the instruction by the controller or the decoder using a look up table or in any other suitable manner. Based on the instruction, the control logic 232 also issues result lane clock information 235, that selects on a per cycle basis, a group of result lane value storage elements 228a-d or 230a-d to store the source lane values (in storage elements 228a-d and 230a-d) that are selected by the multiplexers during a cycle.

For example, the control logic 232 controls the respective result storage elements 228a-228b and 230a-230d to store selected source lane values based on which cycle is being processed. In some implementations a cycle identifier such as a bit (with a “0” indicating the first cycle and a “1” indicating the second cycle) is provided as control information with the instruction that identifies for the control logic which group of output vector result lane positions 0-3 or 4-7 are storing selected source lane values. In some implementations, a first group of output vector result lane positions 0-3 are populated during a first cycle and a second group of output vector result lanes 4-7 are populated during a second cycle. The cross-lane shuffle unit 200, in some implementations, programmably shuffles the respective source lane values 214a-214h and 216a-216h that were generated from the plurality of vector lanes 202a-202h (e.g., FPU lanes) and stored in the VPU register file, to different output vector result lane positions to facilitate a lane value shuffle.

The vector processing unit 116 stores the result lane values from both the first and second cycles in the vector result register 236 as packed vector lane values meaning in full vector width. Vector registers are read and written as full vector width, the VPUs operate on their lane, but the read and write control is for the full vector width.

In operation, the cross-lane shuffle unit 200 provides multicycle lane shuffling by: in a first cycle, controlling the multiplexing logic 218 to select certain of source lane values 214a-216h to be placed in a first group of output vector result lane positions 0-3 for a vector result register 236 and in at least a second cycle, reusing the multiplexing logic 218 to select from the same source lane values 214a-216h to be placed in a second group of output vector result lane positions 4-7 for the vector result register 236 wherein at least one of the selected source lane values is moved to a different result lane position. For example, when the shuffle instruction or operation instructs to shuffle lanes from source register 210 and states to move source lane value (A7) 214h shown to be in lane 7 (the eighth lane) to lane 2 and to move source lane value (B3) 216d from source register 212 in lane 3 to lane 5, in a first cycle the controller controls multiplexer 220c to select input source lane value A7 and output it to storage element 228c which stores results for lane position 2. In a second cycle, the controller controls multiplexer 220b to select input source lane value B3 and output it to storage element 228b which stores results for lane position 5. This is shown in result register 236 having lane positions 2 and 5 with shuffled lane values such that result lane position 2 contains source lane value 214h and result lane position 5 contains source lane value 216d. Result lanes 0, 1, 3, 4, 6, 7 are programmed to have vector values A0, A1, A3, A4, A6 and A7 respectively. It will be recognized that the disclosed structure allows for any source lane value to be shuffled to any result lane position. Also it will be recognized that more than two cycles can be employed and that although four 16:1 multiplexers are shown to be used for an 8 vector lane pipeline, that any suitable structure may be employed based on the size of the vector data.

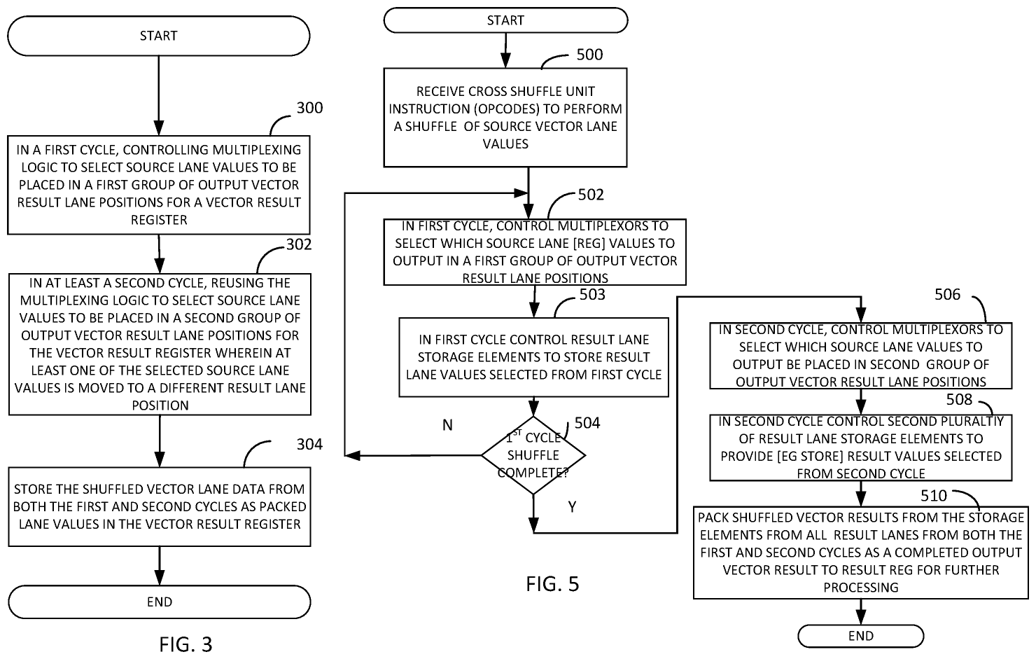

Referring also to FIG. 3, a method for shuffling vector data to different lane positions is illustrated, and in some implementations, is carried out by the multicycle cross-lane shuffle unit 200, however any suitable components may perform the operations. It will be recognized that the order of operations can be changed as desired and for other operations set forth herein. In response to an instruction that utilizes a shuffle operation, the VPU obtains one or more packed source vector lane values from input source vector registers as identified by the instruction operands. As shown in block 300 the method includes shuffling packed source lane values, each corresponding to one of a plurality of vector lanes, to any different output vector result lane positions by, in a first cycle, controlling the multiplexing logic 218 via multiplexer control information 240 to select source lane values to be placed in a first group of output vector result lane positions (e.g. 0-3) via storage elements 228a-228d for the vector result register 236.

As shown in block 302, in at least a second cycle, reusing the multiplexing logic 218 to select source lane values to be placed in a second group of output vector result lane positions (e.g., 4-7) for the vector result register 236 wherein at least one of the selected source lane values 214a-216h is moved to a different result lane position. As shown in block 304, the method includes storing the shuffled vector lane values from both the first and second cycles as packed lane values in the vector result register 236.

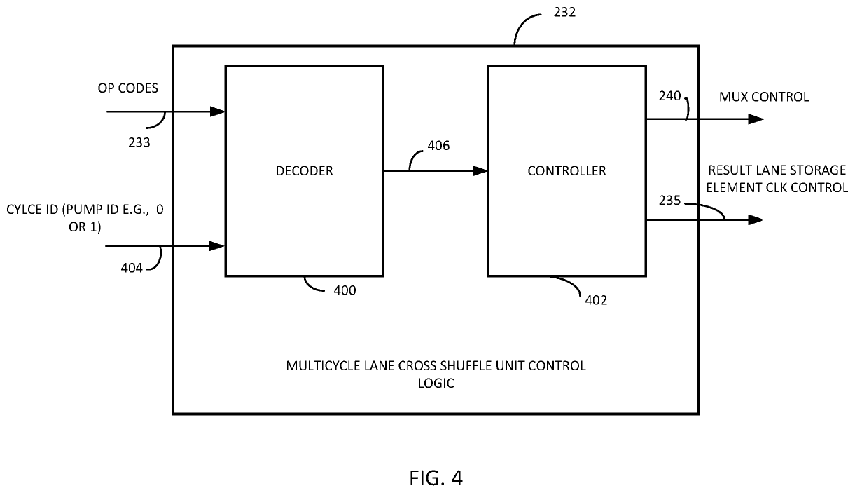

FIG. 4 is a block diagram illustrating one example of multicycle lane cross shuffling unit control logic 232. In one example, the control logic 232 is a microcontroller that executes opcodes, if desired, some of the opcodes can specify using source lane values for mux control 240. The multicycle lane cross shuffling unit control logic 232 includes a decoder 400 and a controller 402. The decoder decodes incoming instructions and receives a cycle identifier 404 included in instruction information that identifies which cycle the instruction is for of a full shuffle operation (e.g., whether the instruction is for a first cycle operation or second cycle operation). The instruction identifies which source lane values to select for each cycle. Once decoded, the decoder sends the decoded instruction information 406 to the controller 402. The controller 402 issues the multiplexer control information 240 to the multiplexers to select the source lane values identified in the decoded information for output to the result lanes and issues the result lane storage element clock signal 235 to a group of vector result lane storage elements based on the cycle identifier.

Some examples of classes of op codes used by the control logic 232 include but are not limited to:
(a) fixed operation op codes that perform a same type of operation such as a single source operand instruction that sets the control for swap lanes 0-3 and puts lane values in output lanes 0-3;
(b) a two source op code such as one that takes source vector values at position A4-A7 and moves them to vector result lanes 0-3 and takes source vector values at position B0-B3 and mo them to vector result lanes 4-7;
(c) source selecting op codes that take vector lane values stored in a source register and use the values to select which source lanes gets passed to which output result lanes; and
(d) programmable opcodes that look at programmable instruction immediate bits that are stored in the opcode and control the multiplexers and vector result lane storage elements accordingly.

In one implementation, only one set of vector result lane storage elements (e.g., 228a-228d) is used for multiple cycles in contrast to multiple sets being used, one for each cycle as illustrated in FIG. 2. In this implementation, the one set of vector result lane storage elements are reused in each cycle and their contents are moved to the result register prior to being written over during the next cycle. For example, the cross-lane shuffle unit places the selected source lane values from the first cycle into a first set of vector result lane storage elements as first vector result lane values, moves the first vector result lane values to the vector result lane register 236 into first lane positions, places the selected source lane values from the second cycle into the vector result lane storage elements as second vector result lane values (thus re-using the same storage elements that were used for the first set of vector result lane values); and moves the second vector result lane values to the same vector result lane register but in different lane positions from the first lane positions to concatenate the first and second vector lane values into a packed lane value in the vector result lane register.

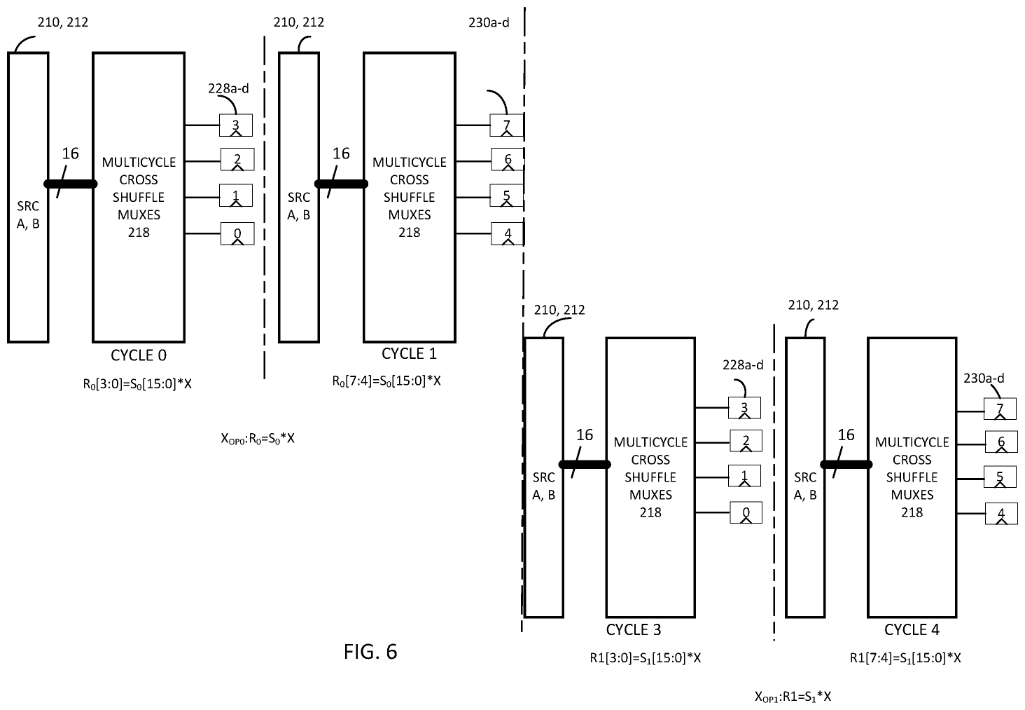

In other implementations, there are multiple sets or groups of vector result lane storage elements, one set being used for each cycle, as shown in FIG. 2. Referring also to FIGS. 5 and 6, FIG. 5 is a flowchart illustrating a method for shuffling vector lane values using multiple sets of vector result lane storage elements (e, g, set 228a-d and set 230a-230d). FIG. 6 is a diagram illustrating a multicycle vector lane shuffling operation for shuffling vector lane values using multiple sets of vector result lane storage elements.

As shown in block 500, the control logic 232 receives an instruction from an instruction queue of the vector processing unit to perform a shuffle of source vector lane values. As shown in block 502, in a first cycle, such as cycle 0 in FIG. 6, the control logic 232 controls multiplexers 220a-220d to select which source lane values (A0-B7) to output in a first group of output vector result lane positions (lanes 0-4). As shown in block 503, the method includes in a first cycle, controlling result lane storage elements 228a-228d (for lanes 0-3) to store result lane values selected by the multiplexers (output by each multiplexer) from the first cycle. As such the controller places the selected source lane values from the first cycle into a first set of vector result lane storage elements 228a-228d. As shown in block 504, the controller determines if the first cycle shuffle is complete. If not, the first cycle operation is continued until complete. If complete, as shown in block 506, and as illustrated in cycle 1 in FIG. 6, in a second cycle, the control logic controls the multiplexers 220a-220d to select source lane values to be placed in any of the second group of output vector result lane positions (lanes 4-7). As noted above this is done based on the instruction identifying the source lane values and the resulting positions that source lane values are to be associated with. As shown in block 508, the method includes also in the second cycle controlling the second group of result storage elements such as 230a-230d, to provide result values selected from the second cycle. As such, the controller places the selected source lane values from the second cycle into a second set of vector result lane storage elements 230a-230d. As shown in block 510 the method includes packing shuffled vector results from the storage elements 228a-230d from both the 1st and 2nd cycles as a completed output vector result to the result register 236 for use in further processing by the vector processing unit. As such as part of a write to register operation, the VPU moves the second vector result lane values to the vector result lane register to concatenate the first and second vector lane values into the vector result lane register. The controller stores contents of the two sets of storage elements into a vector result lane register 236 having a same number of positions as the plurality of vector lanes. The contents of the result vector storage elements for the vector result lane register may be used as operand values for subsequently issued instructions and/or stored to a register file 108. FIG. 6 shows the process repeating for another shuffle operation using cycle 3 and cycle 4.

Among other technical benefits, in some implementations, a VPU shuffle unit is programmable to select individual source lane values by controlling multiplexers over multiple cycles and reuses the same multiplexers that allow any source value from any VPU lane to be placed in any output lane position and is programmable using specific operation codes (e.g., including using the input vector data as an operand). Such shuffle units can be used in an FPU that uses a 512 bit source register with 8 lanes, of 64 bit values, and two cycle (pump) operation (e.g., two cycles to complete where each cycle processes 256 bits). In some examples, a 512 bit source register with 64 lanes, of 8 bit (byte) values, resulting in 64 128:1 multiplexes in the cross-shuffle unit which moves (shuffles) any 8 bit (byte from the source register to any of the output vector byte positions. In one example, there are two 64-byte input vectors (2*512 bits). In some implementations, multiplexing chunks (e.g., vector lane values) are offset by a cycle. This allows shared hardware usage, for example of flops and multiplexers, when processing the input source data to the 64-byte (512-bit) result. Because of the multicycle scheme, there is no need for dedicated multiplexing hardware for each vector lane. The disclosed structure in some implementations is scalable to different sized vector data, different numbers of vector lanes and number of source lane values (which may result in more than two cycles to complete).

Although features and elements are described above in particular combinations, each feature or element can be used alone without the other features and elements or in various combinations with or without other features and elements. The apparatus described herein in some implementations use software or firmware stored on a non-transitory computer-readable storage medium for execution by a general-purpose computer or a processor. Examples of computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). The data stored on the non-transitory computer readable storage medium can then be used (i.e., executed) to create systems (e.g., boards, integrated circuits) that implement various embodiments of the invention.

In the preceding detailed description of the various embodiments, reference has been made to the accompanying drawings which form a part thereof, and in which is shown by way of illustration specific preferred embodiments in which the invention may be practiced. These embodiments are described in sufficient detail to enable those skilled in the art to practice the invention, and it is to be understood that other embodiments may be utilized, and that logical, mechanical and electrical changes may be made without departing from the scope of the invention. To avoid detail not necessary to enable those skilled in the art to practice the invention, the description may omit certain information known to those skilled in the art. Furthermore, many other varied embodiments that incorporate the teachings of the disclosure may be easily constructed by those skilled in the art. Accordingly, the present invention is not intended to be limited to the specific form set forth herein, but on the contrary, it is intended to cover such alternatives, modifications, and equivalents, as can be reasonably included within the scope of the invention. The preceding detailed description is, therefore, not to be taken in a limiting sense, and the scope of the present invention is defined only by the appended claims. The above detailed description of the embodiments and the examples described therein have been presented for the purposes of illustration and description only and not by limitation. For example, the operations described are done in any suitable order or manner. It is therefore contemplated that the present invention covers any and all modifications, variations or equivalents that fall within the scope of the basic underlying principles disclosed above and claimed herein.

The above detailed description and the examples described therein have been presented for the purposes of illustration and description only and not for limitation.

What is claimed is:

1. An integrated circuit comprising:
a vector data processing unit comprising:
multiplexing logic operative to shuffle source lane values each corresponding to one of a plurality of vector lanes, to different output vector result lane positions by:
in a first cycle, controlling the multiplexing logic to select source lane values to be placed in a first group of output vector result lane positions of a memory; and
in at least a second cycle, reusing the multiplexing logic to select source lane values to be placed in a second group of output vector result lane positions of the memory wherein at least one of the selected source lane values is moved to a different output vector result lane position.

2. The integrated circuit of claim 1 wherein the memory is a vector result register.

3. The integrated circuit of claim 2 wherein the multiplexing logic comprises a multiplexer per output vector result lane wherein each multiplexer includes an input coupled to receive the source lane values, and an output that provides a result lane value per output vector result lane.

4. The integrated circuit of claim 3 wherein the multiplexing logic comprises a fewer number of output vector result lanes than a number of the plurality of vector lanes and wherein the vector processing unit stores the result lane values from both the first and second cycles in the vector result register as packed vector lane values.

5. The integrated circuit of claim 3 wherein each multiplexer output is coupled to a respective result lane storage element that stores the selected source values output from each multiplexer during each of the first and at least second cycle and wherein the control logic is operative to control the respective result storage elements to store lane values based on which cycle is being processed.

6. The integrated circuit of claim 2 comprising control logic, operatively coupled to the multiplexing logic, wherein the control logic is operative to programmably control the multiplexing logic to provide multicycle lane shuffling in response to an instruction.

7. The integrated circuit of claim 5 wherein each respective vector result lane storage element comprises a first set of latches corresponding to the first cycle and at least a second set of latches corresponding to the second cycle.

8. The integrated circuit of claim 1 wherein the multiplexing logic is operative to:
place the selected source lane values from the first cycle into a first set of vector result lane storage elements;
place the selected source lane values from the second cycle into a second and different set of vector result lane storage elements; and
store contents of the two sets of storage elements into a vector result register having a same number of positions as the plurality of vector lanes.

9. The integrated circuit of claim 2 wherein the multiplexing logic is operative to:
place the selected source lane values from the first cycle into a first portion of a vector register; and
place the selected source lane values from the second cycle into a second portion of a vector lane register different the first portion thereby concatenating the first and second vector lane values into the vector result register.

10. The integrated circuit of claim 9 wherein the multiplexing logic is operative to:
place the selected source lane values from the first cycle into a first set of vector result lane storage elements as first vector result lane values;
move the first vector result lane values to a vector result register;
place the selected source lane values from the second cycle into the first set of vector result lane storage elements as second vector result lane values; and
move the second vector result lane values to the vector result lane register to concatenate the first and second vector lane values into the vector result register.

11. The integrated circuit of claim 2 wherein the vector processing unit comprises:
the plurality of vector lanes each operative to perform an operation on input vector data and produce respective source lane values for each lane; and to pack the source lane values in a source register.

12. A computer processing system comprising:
a multicore processor comprising:
a plurality of processing cores:
a plurality of floating point processing units (FPUs) wherein each of the FPUs is operatively coupled to at least one of the plurality of processing cores, and wherein each of the plurality of FPUs comprises:
a plurality of FPU lanes each operative to perform a floating point operation on input vector data and produce respective source lane values for each lane; and
a cross-lane shuffle unit operative to programmably shuffle the respective source lane values from the plurality of FPU lanes to different output vector result lane positions wherein the cross-lane shuffle unit comprises:
multiplexing logic having an output result lane configuration of fewer result lanes than a number of FPU lanes;
control logic, operatively coupled to the multiplexing logic, and operative to provide multicycle lane shuffling by:
in a first cycle, controlling the multiplexing logic to select source lane values to be placed in a first group of output vector result lane positions for a vector result register; and
in at least a second cycle, reusing the multiplexing logic to select source lane values to be placed in a second group of output vector result lane positions for the vector result register wherein at least one of the selected source lane values is moved to a different output vector result lane position.

13. The apparatus of claim 12 wherein the multiplexing logic comprises a multiplexer per result lane wherein each multiplexer includes an input coupled to receive the source lane values, and an output that provides a result lane value per result lane position.

14. The apparatus of claim 13 wherein each multiplexer output is coupled to a respective result lane storage element that stores the selected source values output from each multiplexer during each of the first and at least second cycle and wherein the control logic is operative to control the respective result storage elements to store lane values based on which cycle is being processed.

15. The apparatus of claim 12 wherein the control logic is operative to programmably control the multiplexing logic to provide multicycle lane shuffling in response to an instruction.

16. The apparatus of claim 15 wherein the cross-lane shuffle unit is operative to:
place the selected source lane values from the first cycle into a first portion of the vector result register;
place the selected source lane values from the second cycle into a second portion of the vector result register different from the first portion thereby concatenating the first and second vector lane values into the vector result register.

17. The apparatus of claim 15 wherein the cross-lane shuffle unit is operative to:
place the selected source lane values from the first cycle into a first set of vector result lane storage elements;
place the selected source lane values from the second cycle into a second set of vector result lane storage elements; and
store contents of the two sets of storage elements into a vector result register having a same number of positions as the plurality of vector lanes.

18. The apparatus of claim 14 wherein each respective vector result lane storage element comprises a first set of latches corresponding to the first cycle and at least a second set of latches corresponding to the second cycle.

19. The apparatus of claim 16 wherein the cross-lane shuffle unit is operative to:
place the selected source lane values from the first cycle into a first set of vector result lane storage elements as first vector result lane values;
move the first vector result lane values to a vector result lane register;
place the selected source lane values from the second cycle into the first set of vector result lane storage elements as second vector result lane values; and
move the second vector result lane values to the vector result lane register to concatenate the first and second vector lane values into the vector result lane register.

20. A method carried out by a vector data processing unit, the method comprising:
shuffling source lane values, each corresponding to one of a plurality of vector lanes, to different output vector result lane positions by:
in a first cycle, controlling multiplexing logic to select source lane values to be placed in a first group of output vector result lane positions for a vector result register;
in at least a second cycle, reusing the multiplexing logic to select source lane values to be placed in a second group of output vector result lane positions for the vector result register wherein at least one of the selected source lane values is moved to a different result lane position; and
storing the shuffled vector lane data from both the first and second cycles as packed lane values in the vector result register.

21. The method of claim 20 comprising controlling an output result lane storage element for each vector result lane position to store selected source lane values based on which cycle is being processed.

22. The method of claim 20 comprising controlling each respective result storage element such that a first set of storage elements stores result data from the multiplexing logic during the first cycle and at least a second set of storage elements stores result data from the multiplexing logic during the second cycle.

23. The method of claim 20 comprising:
placing the selected source lane values from the first cycle into a first set of vector result lane storage elements as first vector result lane values;
moving the first vector result lane values to a vector result lane register;
placing the selected source lane values from the second cycle into the first set of vector result lane storage elements as second vector result lane values; and
moving the second vector result lane values to the vector result lane register to concatenate the first and second vector lane values into the vector result lane register.
